(19) United States
(12) Patent Application Publication
(10) Pub. No.: US 2026/0367903 A1
(43) Pub. Date: Nov. 19, 2026

(54) AUTOMATED PROVISION OF AN UPDATED RUNTIME ENVIRONMENT

(71) Applicant: INTERNATIONAL BUSINESS MACHINES CORPORATION, ARMONK, NY (US)

(72) Inventors: Tymoteusz Gedliczka, Kraków (PL); Mateusz Piotr Bieda, Kraków (PL); Szymon Brandys, Kraków (PL); Maciej Madej, Kraków (PL); Krzysztof Pitula, Kraków (PL)

(21) Appl. No.: 19/266,411

(22) Filed: Jul. 11, 2025

(30) Foreign Application Priority Data
May 13, 2025 (GB) 2507317.2

(51) Int. Cl. G06F 8/65

(52) U.S. Cl. CPC G06F 8/65

(57) ABSTRACT

The present disclosure relates to a method, a computing device, and a computer program product for an automated provision of an updated runtime environment. The method comprises persisting a dataset of a previous execution of a previous request using a previous runtime environment. The updated runtime environment is implemented. The updated runtime environment is evaluated using the dataset. In response to a positive evaluation, the updated runtime environment is marked as compatible with the solution objective defined by the previous request data.

### BACKGROUND

The present invention relates to the field of digital computer systems, and more specifically, to a method for an automated provision of an updated runtime environment. The present invention further relates to a computing device and a computer program product for an automated provision of an updated runtime environment.

In order to further improve capabilities and results provided by runtime environments for executing requests, e.g., requests received from user applications, the runtime environments may be constantly further developed and updated. However, when using an updated runtime environment, it cannot be excluded that errors and/or problems may arise. Thus, provisioning an updated runtime environment in a way free of errors and problems may prove challenging.

### SUMMARY

In one aspect, the disclosure relates to a method for an automated provision of an updated runtime environment. The method comprises persisting a dataset of a previous execution of a previous request using a previous runtime environment. The dataset comprises previous request data. The previous request data define the previous request and comprise a solution objective of the previous request. The dataset further comprises previous request execution data. The previous request execution data is descriptive of the previous execution of the previous request. The method further comprises implementing the updated runtime environment. The method further comprises evaluating the updated runtime environment using the dataset. The evaluating comprises submitting the previous request data to the updated runtime environment for execution. The evaluating further comprises receiving updated request execution data descriptive of the execution of the previous request by the updated runtime environment. The evaluating further comprises evaluating the received updated request execution data using the previous request execution data. The method further comprises in response to a positive evaluation, marking the updated runtime environment as compatible with the solution objective defined by the previous request data.

In another aspect, the disclosure relates to a computing device for an automated provision of an updated runtime environment. The computing device comprises a processing unit and a memory unit with computer-readable program code embodied therewith. An execution of the computer-readable program code by the processing unit causing the computing device to persist a dataset of a previous execution of a previous request using a previous runtime environment. The dataset comprises previous request data. The previous request data define the previous request and comprise a solution objective of the previous request. The dataset further comprises previous request execution data. The previous request execution data is descriptive of the previous execution of the previous request. The execution further causes the computing device to implement the updated runtime environment. The execution further causes the computing device to evaluate the updated runtime environment using the dataset. The evaluating comprises submitting the previous request data to the updated runtime environment for execution. The evaluating further comprises receiving updated request execution data descriptive of the execution of the previous request by the updated runtime environment. The evaluating further comprises evaluating the received updated request execution data using the previous request execution data. The execution further causes the computing device to mark, in response to a positive evaluation, the updated runtime environment as compatible with the solution objective defined by the previous request data.

In another aspect, the disclosure relates to a computer program product for an automated provision of an updated runtime environment. The computer program product comprises a non-transitory computer-readable storage medium having computer-readable program code embodied therewith. An execution of the computer-readable program code by a processing unit of a computing device causes the computing device to persist a dataset of a previous execution of a previous request using a previous runtime environment. The dataset comprises previous request data. The previous request data define the previous request and comprise a solution objective of the previous request. The dataset further comprises previous request execution data. The previous request execution data is descriptive of the previous execution of the previous request. The execution further causes the computing device to implement the updated runtime environment. The execution further causes the computing device to evaluate the updated runtime environment using the dataset. The evaluating comprises submitting the previous request data to the updated runtime environment for execution. The evaluating further comprises receiving updated request execution data descriptive of the execution of the previous request by the updated runtime environment. The evaluating further comprises evaluating the received updated request execution data using the previous request execution data. The execution further causes the computing device to mark, in response to a positive evaluation, the updated runtime environment as compatible with the solution objective defined by the previous request data.

### BRIEF DESCRIPTION OF THE DRAWINGS

In the following examples are explained in greater detail, by way of example only, making reference to the drawings in which:

FIG. 1 is a flowchart of an exemplary method for an automated provision of an updated runtime environment.

FIG. 2 is a block diagram illustrating an exemplary system for an automated provision of an updated runtime environment.

FIG. 3 is a flowchart of an exemplary method for an automated provision of an updated runtime environment.

FIG. 4 is an exemplary computing environment for an automated provision of an updated runtime environment.

FIG. 5 depicts a cloud computing environment according to an example.

FIG. 6 depicts abstraction model layers according to an example.

### DETAILED DESCRIPTION

The descriptions of the various examples of the present disclosure will be presented for purposes of illustration but are not intended to be exhaustive or limited to the examples disclosed. Many modifications and variations will be apparent to those of ordinary skill in the art without departing from the scope and spirit of the examples described. The terminology used herein was chosen to best explain the principles of the examples, the practical application or technical improvement over technologies found in the marketplace, or to enable others of ordinary skill in the art to understand the examples disclosed herein.

Examples may provide a method for an automated provision of an updated runtime environment. The method may comprise persisting a dataset of a previous execution of a previous request using a previous runtime environment. The dataset may comprise previous request data, which define the previous request and comprise a solution objective of the previous request. The dataset may further comprise previous request execution data, which are descriptive of the previous execution of the previous request. The updated runtime environment may be implemented.

The updated runtime environment may be evaluated using the dataset. The evaluating may comprise submitting the previous request data to the updated runtime environment for execution, receiving updated request execution data descriptive of the execution of the previous request by the updated runtime environment, and evaluating the received updated request execution data using the previous request execution data.

In response to a positive evaluation, the updated runtime environment may be marked as compatible with the solution objective defined by the previous request data.

Examples may have the beneficial effect that data of previous executions of previous requests, which are stored, may be employed to automatically verify a compatibility of the updated runtime environment. Thereby, e.g., a risk of performance issues may be reduced.

Examples may further have the beneficial effect that runtime environment updates may be validated against real execution parameters. This may, e.g., enable a more reliable and efficient runtime provisioning process.

For example, the method may further comprise, in response to a negative evaluation, not marking the updated runtime environment as compatible with the solution objective defined by the previous request data.

For example, the previous request execution data may comprise a previous execution time required for the previous execution of the previous request by the previous runtime environment. The updated request execution data may comprise an updated execution time required for the updated execution of the previous request by the updated runtime environment. The evaluating of the received updated request execution data may comprise a checking that for the previous request data the updated execution time is not longer than the previous execution time.

Examples may have the beneficial effect that comparing previous and updated execution times may ensure that a performance is, e.g., at least maintained or even improved. Thereby, e.g., a regression in service speed may be prevented.

Examples may further have the beneficial effect that only those updated runtime environments may be marked as compatible and provided for an automatic selection that do not increase execution time. This may, e.g., enable an ensuring of a consistent and efficient request processing.

For example, the previous request execution data may comprise previous solution data for the solution objective. The solution data may result from the execution of the previous request by the previous runtime environment. The updated request execution data may comprise updated solution data for the solution objective. The updated solution data may result from the updated execution of the previous request by the updated runtime environment. The evaluating of the received updated request execution data may comprise a checking that for the previous request data a quality of the updated solution data according to a quality metric of the updated solution data is not less than a quality of the previous solution data according to a quality metric of the previous solution data.

Examples may have the beneficial effect that verifying the quality of updated solution data against previous solution data may guarantee that improvements or at least equivalent performance levels are achieved using the updated runtime environment.

Examples may further have the beneficial effect that the evaluation process may systematically ensure that the updated runtime environment meets or exceeds established quality metrics. Thereby, e.g., an overall system effectiveness enhancement may be enabled.

For example, the quality metric of the previous solution data may comprise a quantitative metric. For example, the quality metric of the updated solution data may comprise a quantitative metric.

For example, the quality metric of the previous solution data may comprise a previous objective value of the previous solution data. The quality metric of the updated solution data may comprise an updated objective value of the updated solution data.

Examples may have the beneficial effect that using quantitative metrics, such as objective values of determined solutions, which may, e.g., be integer values, for evaluation may provide an objective basis for performance comparison, in particular in optimization problems.

Examples may further have the beneficial effect that clear, measurable criteria may be established and used for the runtime environment evaluation. This may, e.g., result in a more transparent and reproducible selection process for selecting a runtime environment for an execution of a request.

For example, for an optimization problem in form of a minimization problem, the smaller an objective value of a solution is, the better the solution may be. For example, for an optimization problem in form of a maximization problem, the larger an objective value of a solution is, the better the solution may be.

For example, the evaluating of the received updated request execution data may further comprise checking that the updated request execution data does not comprise an error message.

Examples may have the beneficial effect that checking for error messages in the updated execution data may help to prevent a deployment of a faulty and thus incompatible runtime environment. Thereby, e.g., a system reliability may be increased.

Examples may further have the beneficial effect that an integrated error-detection mechanism may be implemented. This may, e.g., result in an automated notification and/or enhanced user trust in the system's operation.

For example, the persisting may comprise a storing of the dataset in an execution history database.

For example, the method may further comprise sending a compatibility notification to one or more user applications notifying about the compatibility of the updated runtime environment with the solution objective defined by the previous request data.

For example, the method may further comprise generating an evaluation report summarizing the evaluation.

Examples may have the beneficial effect that generating an evaluation report may provide a detailed overview of the updated runtime environment's performance. Thereby, e.g., continuous improvement may be supported. Furthermore, the evaluation and its result may be comprehensible for a user.

Examples may further have the beneficial effect that users may receive a comprehensive feedback on system performance. This may, e.g., enable proactive adjustments and/or a better-informed decision-making.

For example, the evaluation report may comprise a summary of key performance indicators of the execution by the updated runtime environment and of the previous execution by the previous runtime environment. For example, the evaluation report may comprise a summary of a comparison of key performance indicators of the execution by the updated runtime environment with key performance indicators of the previous execution by the previous runtime environment.

For example, the evaluation report may comprise a summary of the comparison of the updated execution time with the previous execution time. For example, the evaluation report may comprise a summary of the comparison of the updated solution data with the previous solution data. For example, the evaluation report may comprise a summary of received error messages.

Examples may have the beneficial effect that the evaluation report may systematically present key performance indicators and/or a comparison of key performance indicators. The key performance indicators may, e.g., comprise execution times, solution data, and/or error messages. The comparison of key performance indicators may, e.g., comprise a comparison of execution times and/or solution data. This may, e.g., enable and/or result in an evidence-based assessment of compatibility.

Examples may further have the beneficial effect that summarizing comparisons of execution times, comparisons of solution data, and/or error messages may yield a holistic view of the updated runtime environment's performance. Thereby, e.g., a transparency of the updated runtime environment's performance may be enhanced.

For example, the method may further comprise sending a notification with the evaluation report to one or more user applications notifying about the compatibility of the updated runtime environment with the solution objective defined by the previous request data and about the evaluation.

Examples may have the beneficial effect that sending a notification with the evaluation report ensures that user applications and/or users using the respective applications may be informed, e.g., promptly informed, about the updated environment's compatibility.

Examples may further have the beneficial effect that automated notifications may enable a streamlining of the decision-making process. This may, e.g., result in a more efficient operational management.

For example, the method may further comprise automatically instructing a deployment dispatcher module to switch to the updated runtime environment for executions of further requests defined by further request data comprising a further solution objective matching the solution objective with which the updated runtime environment is marked to be compatible.

Examples may have the beneficial effect that an automated seamlessly transition to the updated runtime environment is enabled. This may, e.g., result in an uninterrupted service performance.

Examples may further have the beneficial effect that automatically instructing a deployment dispatcher to switch to the compatible updated runtime environment may minimize manual intervention. Furthermore, a usage of a most recent runtime environment may be ensued. The updated runtime environment may, e.g., be a most optimized runtime environment of all available runtime environments.

For example, the updated runtime environment may be a latest runtime environment of a plurality of runtime environments, which are marked to be compatible with the solution objective of the updated runtime environment. For example, the switching to the updated runtime environment may be a switching to the latest runtime environment marked to be compatible with the respective solution objective.

For example, the deployment dispatcher module may be configured for switching automatically to a latest runtime environment of a plurality of runtime environments, which are marked to be compatible with the solution objective of the updated runtime environment. For example, the deployment dispatcher module may be configured for switching automatically to a latest runtime environment without a specific user interaction requesting and/or initiating the switching.

For example, the previous runtime environment may be marked to be compatible with the solution objective defined by the previous request data. In case the updated runtime environment is not marked as compatible with the solution objective defined by the previous request data, the previous runtime environment may be continuously used for executions of requests defined by request data comprising a solution objective matching the respective solution objective. For example, the previous runtime environment may be the latest runtime environment marked to be compatible with the respective solution objective.

For example, the method may further comprise sending a switching notification about the automatic switching to user applications, from which the further requests are received.

Examples may have the beneficial effect that sending a switching notification may inform user applications and/or users using the respective applications of the switching and of the resulting change regarding the usage of runtime environments. Thereby, e.g., an overall system transparency may be enhanced.

Examples may further have the beneficial effect that end-users may, e.g., be aware of the automatic update process. This may, e.g., result in an improved trust and smoother operational transitions.

For example, the previous runtime environment may use a previous version of a programming language for executing the previous request and the updated runtime environment may use an updated version of the programming language for executing the previous request.

Examples may have the beneficial effect that employing an updated version of a programming language may leverage improvements in language efficiency and/or features. Thereby, e.g., an improved execution may be enabled. For example, an optimized execution may be enabled.

Examples may further have the beneficial effect that the transition from an older to a newer programming language version may be seamlessly integrated. This may result in an enhanced system performance and/or security.

For example, the previous runtime environment and the updated runtime environment may be configured for solving optimization problems. The previous runtime environment may comprise a previous optimization engine configured for determining results of optimization problems and the updated runtime environment may comprise an updated optimization engine configured for determining results of optimization problems.

Examples may have the beneficial effect that integrating an updated optimization engine may allow for more advanced algorithms to be used. Thereby, e.g., solution outcomes in complex optimization problems may be improved.

Examples may further have the beneficial effect that the updated runtime environment may offer superior optimization capabilities. This may, e.g., result in increased computational efficiency and/or accuracy.

For example, the previous request data may comprise input data with values defining a setup for a problem for which the solution objective is to be determined.

Examples may have the beneficial effect that including input data for problem setup in the persisted previous request data may enable an automated runtime environment evaluation. The values defining the setup for the problem may be used for setting up the problem using the updated runtime environment. For example, system performance may be aligned with specific problem requirements.

For example, the solution objective may be comprised by a model. The model may further define one or more constraints of the problem for which the solution objective is to be determined.

Examples may have the beneficial effect that defining the solution objective by means of a model with explicit constraints may facilitate a structured evaluation. Thereby, e.g., targeted optimization may be supported.

Examples may further have the beneficial effect that the runtime environment may be assessed in the context of clearly defined constraints, which may result in an improved accuracy in determining compatibility of the updated runtime environment, in particular in context of complex problem models.

For example, the problem may be an optimization problem.

For example, a plurality of datasets of previous executions of a plurality of requests is persisted and at least a part of the plurality of the persisted datasets is used for the evaluating of the updated runtime environment. The updated runtime environment may be marked compatible with all solution objectives defined by the datasets, for which the evaluation is positive.

Examples may have the beneficial effect that a plurality of historical datasets may be used allowing for a strengthening of the evaluation process by considering diverse execution scenarios. Thereby, e.g., reliability of the evaluation may be increased.

For example, the part of the plurality of persisted datasets used for the evaluating of the updated runtime environment may be datasets selected from the plurality of persisted datasets using a selection criterion.

Examples may have the beneficial effect that defining a selection criterion for the purpose of selecting persisted datasets to be used for the evaluating may enable an automation of the selecting and thus of the evaluating.

For example, the selection criterion may be a predefined number of latest datasets of the plurality of persisted datasets.

For example, the selection criterion may be a predefined number of latest datasets of the plurality of persisted datasets with different solution objectives.

Examples may have the beneficial effect that applying a selection criterion based on recency and/or diversity of solution objectives may ensure that the evaluation remains current and/or comprehensive.

Examples may further have the beneficial effect that the system may benefit from a balanced data set reflecting multiple performance scenarios. This may, e.g., result in an improved runtime environment assessment.

Examples may provide a computing device for an automated provision of an updated runtime environment. The computing device may comprise a processing unit and a memory unit with computer-readable program code embodied therewith. An execution of the computer-readable program code by the processing unit may cause the computing device to persist a dataset of a previous execution of a previous request using a previous runtime environment. The dataset may comprise previous request data, which define the previous request and comprise a solution objective of the previous request. The dataset may further comprise previous request execution data, which are descriptive of the previous execution of the previous request. The updated runtime environment may be implemented.

The updated runtime environment may be evaluated using the dataset. The evaluating may comprise submitting the previous request data to the updated runtime environment for execution, receiving updated request execution data descriptive of the execution of the previous request by the updated runtime environment, and evaluating the received updated request execution data using the previous request execution data.

In response to a positive evaluation, the updated runtime environment may be marked as compatible with the solution objective defined by the previous request data.

For example, an execution of the computer-readable program code by the processing unit of the computing device may cause the computing device to execute any example of the method for the automated provision of the updated runtime environment described herein.

For example, the updated runtime environment may be provided as a service in a cloud environment.

Examples may provide a computer program product for an automated provision of an updated runtime environment. The computer program product may comprise a non-transitory computer-readable storage medium having computer-readable program code embodied therewith. An execution of the computer-readable program code by a processing unit of a computing device may cause the computing device to persist a dataset of a previous execution of a previous request using a previous runtime environment. The dataset may comprise previous request data, which define the previous request and comprise a solution objective of the previous request. The dataset may further comprise previous request execution data, which are descriptive of the previous execution of the previous request. The updated runtime environment may be implemented.

The updated runtime environment may be evaluated using the dataset. The evaluating may comprise submitting the previous request data to the updated runtime environment for execution, receiving updated request execution data descriptive of the execution of the previous request by the updated runtime environment, and evaluating the received updated request execution data using the previous request execution data.

In response to a positive evaluation, the updated runtime environment may be marked as compatible with the solution objective defined by the previous request data.

For example, an execution of the computer-readable program code by the processing unit of the computing device may cause the computing device to execute any example of the method for the automated provision of the updated runtime environment described herein.

Examples may be cloud-based. For example, the runtime environments, like the previous runtime environment and the updated runtime environment, may be provided via a cloud.

Examples may allow for an automatic updating of a runtime environment in a safe way. An updated runtime may be implemented and automatically evaluated using stored datasets of previous executions of previous requests, i.e., historical request. The datasets of the previous executions may comprise previous request data of the previous requests as well as previous request execution data of the previous executions of previous requests using previous runtime environments. In case a result of the evaluation of the updated runtime environment is positive and the updated runtime environment is marked as being compatible with a solution objective defined by the previous request data, an automatic switching to the updated runtime environment may be implemented for executions of requests with a solution objective matching the solution objective with which the updated runtime environment is proven to be compatible. Such an automatic switching to, i.e., making available of an updated runtime environment only after a successful evaluation, may ensure that problems caused by a potential incompatibility of the updated runtime environment with requests may be avoided. Thus, a safe approach for switching to an updated runtime environment may be provided. The updated runtime environment may, e.g., be configured for solving optimization problems. For example, the updated runtime environment may comprise an updated optimization engine. Thus, examples may provide a method to safely update an optimization engine, i.e., providing an updated optimization engine in an automatic way. For example, the updated optimization engine of the updated runtime environment may be a latest optimization engine of a plurality of optimization engine provided by a plurality of runtime environments. Thus, users of optimization software, e.g., of applications configured for using the respective runtime environments, may be enabled to have their optimization models benefit from the latest optimization engine without regression risk.

Regression risk refers to the possibility that changes and/or enhancements introduced by the updated runtime environment may inadvertently reintroduce previously fixed bugs and/or cause new issues in areas that were previously working correctly. This risk may be particularly relevant during software or system updates when modifications, like bug fixes, new features, and/or performance improvements, might have unforeseen side effects on existing functionality.

An optimization engine may be configured to solve various types of optimization problems including linear programming (LP), mixed integer programming (MIP), and quadratic programming (QP), among others. It employs, e.g., robust algorithms such as simplex method, interior-point (barrier) method, and branch-and-bound for mixed integer problems, making it effective for large-scale and complex models. APIs in several programming languages, like Python, C++, Java, and C#, may be offered to allow seamless integration into custom applications and workflows. An optimization engine may be used for solving optimization problems in a wide range of applications, in particular industrial applications, like logistics, manufacturing, and telecommunications for tasks such as supply chain optimization, scheduling, resource allocation, and network design.

The runtime environments, may, e.g., be runtime environments provided on a platform for solving optimization tasks. The platform may, e.g., be a cloud-based environment configured for providing runtime environments, e.g., runtime environments for solving optimization tasks. For solving the optimization tasks, the runtime environments may, e.g., comprise optimization engines. In prescriptive analytics, when solving an optimization task using a runtime environment provided on a platform, e.g., there may, e.g., be the following three elements that affect a final output: model, input data and optimization engine being used.

The model may define an optimization objective, i.e., a solution objective of an optimization problem to be solved, and/or one or more constraints of the respective optimization problem. For example, in the field of cargo transportation an optimization problem may, e.g., be a problem of optimally loading cargo onto vehicles. In such a case, an optimization objective of a model could be a minimization of total cost of transport. Exemplary constraints of the respective optimization problem may, e.g., be maximal capacities of the individual vehicles available for loading, which are not allowed to be exceeded.

The input data may, e.g., comprise all variables of a particular situation, for which the optimization problem is to be solved. In the aforementioned example, the input data may, e.g., comprise a list of cargo items to be transported. The list of cargo items may, e.g., comprise parameters descriptive of these cargo items, like sizes, weights, and/or delivery destinations of the cargo items. In the aforementioned example, the input data may, e.g., further comprise a list of available vehicles. The list of available vehicles may, e.g., comprise parameters descriptive of these vehicles, like weight and/or volume capacities, and/or average fuel costs per kilometer driven.

The optimization engine is a computer program, which is configured for processing a model and input data, e.g., provided by a user, and to generate output data with a solution to the optimization problem defined by the model and the input data. In the aforementioned example, the output data may, e.g., define a number of required vehicles of each type available and an assignment of each cargo item to one of the respective available vehicles.

Depending on a complexity of an optimization problem, the optimization engine may take seconds to hours or even days for providing a solution.

Runtime environments may, e.g., be continuously developed and improved to provide new features and/or increase a speed of running jobs using the respective runtime environments. For example, optimization engines provided by runtime environments may, e.g., be continuously developed and improved to provide new features and/or increase a speed of running optimization jobs using the respective optimization engines.

On a platform, multiple runtime environments may be available at the same time. The multiple runtime environments may, e.g., provide multiple optimization engine versions. A user may, e.g., have to choose a runtime environment to execute a job. For example, choosing a runtime environment may, e.g., mean choosing an optimization engine version for a solve run, i.e., to execute a request to solve an optimization problem. Thus, the runtime environment may, e.g., be chosen based on a version of the optimization engine provided by the respective runtime environment. Furthermore, different runtime environments may, e.g., use different versions of a programming language. For example, the runtime environment may be chosen based on a version of the programming language used by the respective runtime environment. For example, when the model is defined using API in a general-purpose language, such as Python, multiple versions of the respective language may be available for user to choose.

In general, it may, e.g., be beneficial to use a latest runtime environment. The latest runtime environment may, e.g., provide a latest optimization engine version. A newer version may, e.g., be expected to deliver improvements. Such improvements may, e.g., reduce a solve time and/or improve a solution objective in case of a feasible solution. A feasible solution is, e.g., a solution that satisfies all the constraints of a model and/or that is a best solution of explored valid solutions. But it may, e.g., be known there could be even a better solution, i.e., an optimal solution, that was not found. This may, e.g., happen if the solve is time constrained, because it converges to an optimal solution too slowly. Thus, an improved solution objective may be closer to the optimal solution compared to solution objectives provided by previous versions of the optimization engine.

However, there may be no guarantee that an improvement by a newer version of an optimization engine will take place for every combination model and input data. It may happen, e.g., that a model exhibits some kind of corner case for which a newer optimization engine version performs worse compared to previous versions. For example, the newer optimization engine may be slower for a particular model, i.e., a solution time may be longer. For example, the newer optimization engine may produce worse feasible solutions for a particular model. A newer optimization engine may, e.g., even fail to find a solution at all for a particular model. Therefore, it may not always be desired to automatically use a latest version, because of the regression risk.

Consequently, in most cases it could, e.g., be beneficial to use the latest runtime environment with the latest optimization engine. But using the latest runtime environment automatically may entail a risk of regression. Examples may provide an approach for enabling a usage of an updated runtime environment, e.g., comprising an updated optimization engine, in a regression free and thus safe way.

Examples may enable a seamless switching to a newer runtime environment for executing a request by re-executing selected prior, i.e. previous, execution requests. For example, for a given optimization model a seamless switching to a newer version of an optimization engine provided by the newer runtime environment may be enabled by re-running the selected prior optimization jobs. The prior optimization jobs may, e.g., be optimization jobs using the same optimization model.

Examples may, e.g., enable a faster adoption of a new runtime environment. Examples may, e.g., enable a faster adoption of a new optimization engine version provided by the newer runtime environment. Examples may, e.g., enable a shorter feedback loop on a new runtime environment. Examples may, e.g., enable a shorter feedback loop on a new optimization engine version provided by the newer runtime environment.

Examples may, e.g., enable more successful executions of requests, when making available a new runtime environment. Examples may, e.g., enable more successful executions of requests, when making available a new optimization engine version provided by the newer runtime environment. Examples may, e.g., achieve better results for requests using a new runtime environment. Examples may, e.g., achieve better results for executing optimization models using a new optimization engine version provided by the newer runtime environment. Examples may, e.g., provide an effective error prevention approach for using a new runtime environment. Examples may, e.g., provide an effective error prevention approach for using a new optimization engine version provided by the newer runtime environment.

For example, the persisting of datasets of previous executions of previous requests using previous runtime environments may comprise a capturing of historical workload input and output of the previous runtime environments. Upon an availability of a new runtime environment version, i.e., an updated runtime environment, the captured historical workloads may be replayed automatically using the updated runtime environment. For this purpose, the respective historical workload input may be used. Results of the replayed historical workload input may be used for evaluating the updated runtime environment. For this purpose, the results, i.e., output of the replay may be compared with the historical workload output. Thus, a regression verification of the updated environment's results against the historical workload output may be implemented. Based on this evaluation of the updated runtime environment, a compatibility of the updated runtime environment may be determined. The updated runtime environment may, e.g., be automatically used for an execution of such requests, with which it is assessed to be compatible based on the evaluation. For example, it may be automatically switched to the updated runtime environment for executions of requests defined by request data comprising a solution objective matching the solution objective with which the updated runtime environment has been determined to be compatible.

For example, by evaluating the updated runtime environment an updated optimization engine provided by the updated runtime environment may be evaluated. Based on this evaluation of the updated runtime environment, a compatibility of the optimization engine may be determined. The updated optimization engine may, e.g., be automatically used for an execution of such requests, i.e., optimization jobs, for which it is assessed to be compatible based on the evaluation. These may, e.g., be optimization jobs with optimization models matching optimization models of historic optimization jobs, for which the compatibility of the updated optimization engine has been successfully checked.

For example, the updated runtime environment to be evaluated may differ from the previous runtime environment in an optimization engine comprised by the updated runtime environment. For example, the updated runtime environment may comprise an updated optimization engine, while the previous runtime environment may comprise a previous optimization engine. The evaluation of the updated runtime environment may, e.g., be based on an evaluation of the updated optimization engine. For example, results provided using the updated optimization engine may be compared with results provided using the previous optimization engine.

For example, users may be notified via user interfaces and/or other communication channels about the compatibility of the updated runtime environment. For example, a deployment dispatcher may switch a target runtime environment for an execution of requests to the updated runtime environment marked as compatible. For example, a deployment dispatcher may switch to the updated runtime environment automatically without any explicit user action. For example, the deployment dispatcher may notify users via user interfaces and/or other communication channels about the switching, i.e., about the automatically performed upgrade to the updated runtime environment. For example, a notification by the deployment dispatcher may include a report summarizing performed test executions using historical execution data. The report may, e.g., comprise a comparison of execution results and/or execution times between the previous runtime environment and the updated runtime environment marked as compatible.

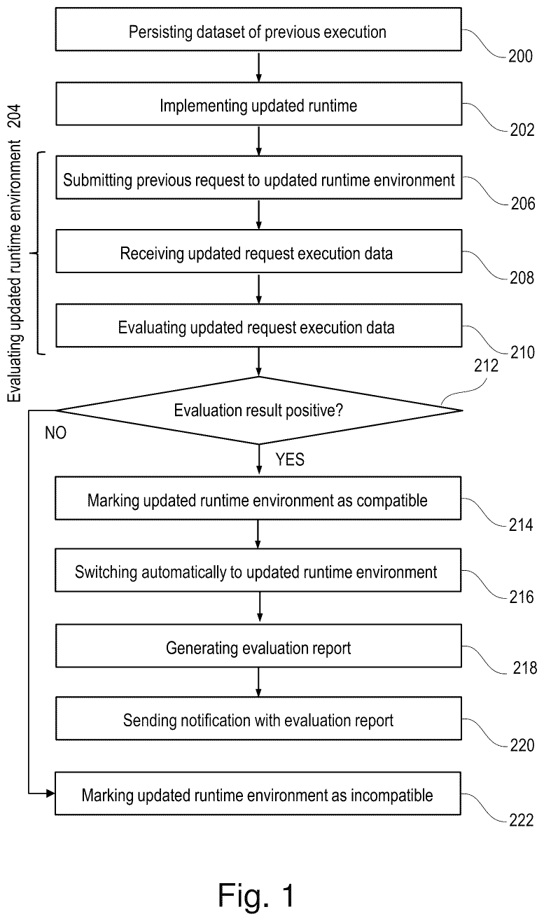

FIG. 1 is a flowchart of an exemplary method for an automated provision of an updated runtime environment.

In block 200, a dataset of a previous execution of a previous request is persisted using a previous runtime environment. For example, the persisting comprises a storing of the dataset in an execution history database. The dataset comprises previous request data, which define the previous request and comprise a solution objective of the previous request. The dataset further comprises previous request execution data, which are descriptive of the previous execution of the previous request. For example, the previous request execution data may comprise a previous execution time required for the previous execution of the previous request by the previous runtime environment. For example, the previous request execution data may comprise previous solution data for the solution objective. The solution data may, e.g., result from the execution of the previous request by the previous runtime environment.

For example, the previous request data comprise input data with values defining a setup for a problem for which the solution objective is to be determined. The solution objective may, e.g., be comprised by a model. The model may further define one or more constraints of the problem for which the solution objective is to be determined. The problem may, e.g., be an optimization problem.

In block 202, the updated runtime environment is implemented. In block 204, the updated runtime environment is evaluated using the dataset. The evaluating comprises in block 206 submitting the previous request data to the updated runtime environment for execution.

For example, a plurality of datasets of previous executions of a plurality of requests is persisted and at least a part of the plurality of the persisted datasets is used for the evaluating of the updated runtime environment. The updated runtime environment may be marked compatible with all solution objectives defined by the datasets, for which the evaluation is positive. For example, the part of the plurality of persisted datasets used for the evaluating of the updated runtime environment being datasets selected from the plurality of persisted datasets using a selection criterion. The selection criterion may, e.g., be one of the following: a predefined number of latest datasets of the plurality of persisted datasets, a predefined number of latest datasets of the plurality of persisted datasets with different solution objectives.

The previous request may be executed by the updated runtime environment using the previous request data and, in block 208, updated request execution data may be received. The updated request execution data are descriptive of the execution of the previous request by the updated runtime environment.

For example, the previous runtime environment may use a previous version of a programming language for executing the previous request, while the updated runtime environment may use an updated version of the programming language for executing the previous request.

For example, the previous runtime environment and the updated runtime environment may be configured for solving optimization problems. The previous runtime environment may, e.g., comprise a previous optimization engine configured for determining results of optimization problems, while the updated runtime environment may comprise an updated optimization engine configured for determining results of optimization problems.

For example, the updated request execution data may comprise an updated execution time required for the updated execution of the previous request by the updated runtime environment. For example, the updated request execution data may comprise updated solution data for the solution objective. The updated solution data may, e.g., result from the updated execution of the previous request by the updated runtime environment.

In block 210, the received updated request execution data is evaluated using the previous request execution data. For example, the evaluating of the received updated request execution data may comprise a checking that for the previous request data the updated execution time is not longer than the previous execution time.

For example, the evaluating of the received updated request execution data may comprise a checking that for the previous request data a quality of the updated solution data according to a quality metric of the updated solution data is not less than a quality of the previous solution data according to a quality metric of the previous solution data. For example, the quality metric of the previous solution data may comprise a previous objective value of the previous solution data. The quality metric of the updated solution data may, e.g., comprise an updated objective value of the updated solution data. For example, for an optimization problem in form of a minimization problem, the smaller an objective value of a solution is, the better it is considered. For example, for an optimization problem in form of a maximization problem, the larger an objective value of a solution is, the better it is considered.

For example, the evaluating of the received updated request execution data may further comprise checking that the updated request execution data does not comprise an error message.

In block 212, it is checked, whether a result of the evaluation in block 210 is positive. In response to a positive evaluation according to block 212, the updated runtime environment is marked as compatible with the solution objective defined by the previous request data in block 214. For example, a compatibility notification is sent to one or more user applications notifying about the compatibility of the updated runtime environment with the solution objective defined by the previous request data.

In block 216, a deployment dispatcher module may be automatically instructed to switch to the updated runtime environment for executions of further requests, which are defined by further request data comprising a further solution objective matching the solution objective with which the updated runtime environment is marked to be compatible.

For example, the updated runtime environment is a latest runtime environment of a plurality of runtime environments, which are marked to be compatible with the solution objective of the updated runtime environment. For example, the switching to the updated runtime environment is a switching to the latest runtime environment marked to be compatible with the respective solution objective.

For example, the deployment dispatcher module is configured for switching automatically to a latest runtime environment of a plurality of runtime environments, which are marked to be compatible with the solution objective of the updated runtime environment. For example, the deployment dispatcher module is configured for switching automatically to a latest runtime environment without a specific user interaction requesting and/or initiating the switching.

For example, the previous runtime environment is marked to be compatible with the solution objective defined by the previous request data. In case the updated runtime environment is not marked as compatible with the solution objective defined by the previous request data, the previous runtime environment may be continuously used for executions of requests defined by request data comprising a solution objective matching the respective solution objective. For example, the previous runtime environment is the latest runtime environment marked to be compatible with the respective solution objective.

For example, a switching notification about the automatic switching in block 216 may be sent to user applications, from which the further requests are received. For example, the switching notification about the automatic switching may be sent to a user application, in case an automatic switching to the updated runtime environment is executed for a request from this user application.

In block 218, an evaluation report summarizing the evaluation is generated. The evaluation report may, e.g., comprise one or more of the following: a summary of the comparison of the updated execution time with the previous execution time; a summary of the comparison of the updated solution data with the previous solution data.

The evaluation report may, e.g., comprise and/or be added to the compatibility notification.

In block 220, a notification with the evaluation report may be sent to one or more user applications. The notification may, e.g., comprise the compatibility notification. The notification may notify the user applications about the compatibility of the updated runtime environment with the solution objective defined by the previous request data and about the evaluation.

In response to a negative evaluation according to block 212, the updated runtime environment is not marked as compatible with the solution objective defined by the previous request data. For example, the updated runtime environment may even be marked incompatible with the solution objective defined by the previous request data in block 222. An evaluation report summarizing the evaluation may also be generated and sent to one or more user applications. In case of a negative evaluation due to errors indicated by received error messages, the evaluation report may, e.g., comprise a summary of the received error messages.

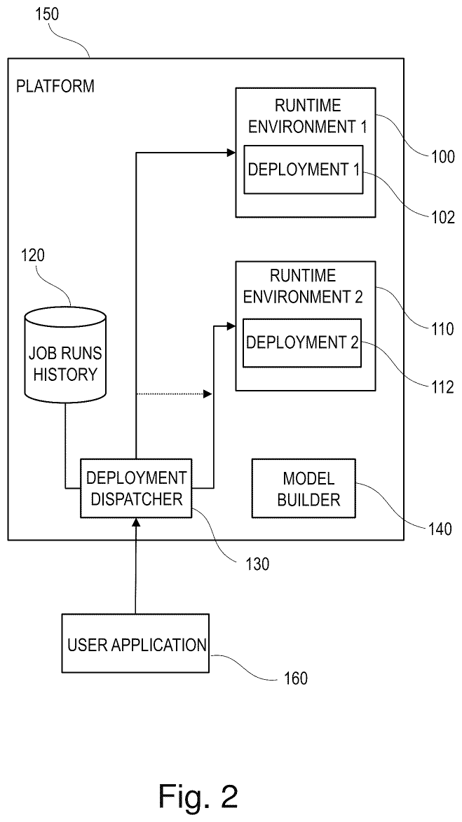

FIG. 2 is a block diagram illustrating an exemplary system for an automated provision of an updated runtime environment. A platform 150 may be provided for executing requests by user applications 160. A user, i.e., user application 160, may, e.g., create a first model deployment 102, i.e., deployment 1, using a first runtime environment 100 provided on the platform 150. The model deployment 102 may be created using a model builder 140 provided on the platform 150 for creating model deployments. The user application 160 may not get direct access to a deployment endpoint, e.g., model deployment 102, but rather an indirect access via a deployment dispatcher module 130 provided by the platform 150. For communicating with the deployment dispatcher module 130, the user application 160 may, e.g., use a REST Client. Input data and solution data of selected job runs using model deployment 102 may be recorded for reference in a job runs history database 120.

When an updated second runtime environment 110 is implemented on platform 150, e.g., an updated second model deployment 112, i.e., deployment 2, using the second runtime environment 110 may be created automatically. The updated model deployment 112 may be created using the model builder 140 provided on the platform 150. The updated model deployment 112 may, e.g., be configured for using an updated optimization engine and/or an updated programming language provided by the updated runtime environment 110 for executing requests by the user application 160. At this point, requests sent by user application 160 to deployment dispatcher module 130 for execution may still be proxied to deployment 102 by the deployment dispatcher module 130. Reference job runs using the jobs stored for reference in a job runs history database 120 may be automatically executed using the update deployment 112 of the updated runtime environment 110 for evaluation of the updated runtime environment 110.

Upon a positive evaluation of the reference job runs, the updated runtime environment 110 may be marked compatible with solution objectives of these reference job runs. The deployment dispatcher module 130 may start proxying requests of user application 160, for which the solution objectives match the solution objectives, for which the updated runtime environment 110 is marked compatible, to the updated model deployment 112 in the updated runtime environment 110. This switching from runtime environment 100 to updated runtime environment 110 is indicted by the dotted arrow. Thereby, the user application 160 may benefit from the automatic usage of the updated model deployment 112 in the updated runtime environment 110, without requiring the user application 160 to initiate the creating of the updated deployment 112 and/or the switching. In case a request is received from the user application 160 with a solution objective that matches a solution objective, for which the updated runtime environment 110 is not marked compatible or even marked incompatible, the respective request may be proxied to the first deployment 102 of the first runtime environment as before. Thus, potential errors and/or problems which could arise from using the updated model deployment 112 in the updated runtime environment 110, may be effectively prevented. Furthermore, the user application 160 may be informed about the automatic switching.

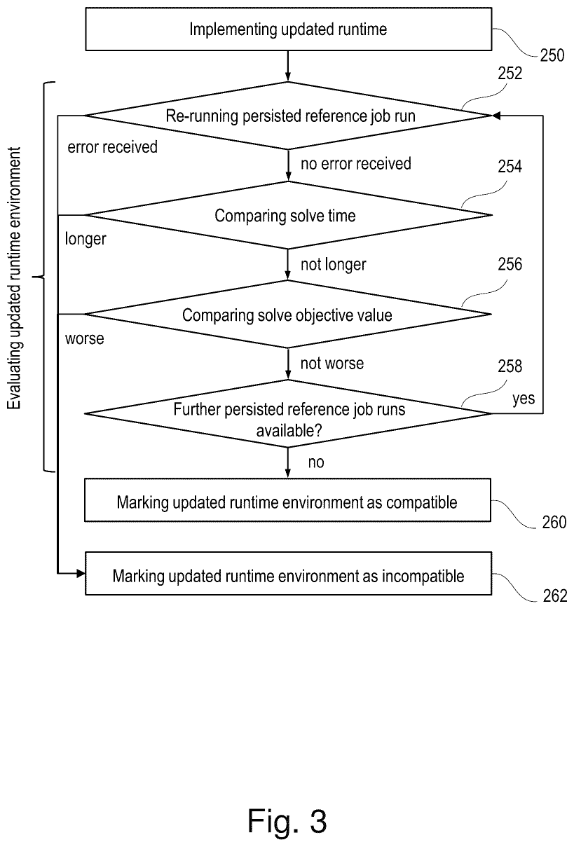

FIG. 3 is a flowchart of an exemplary method for an automated provision of an updated runtime environment. This method may comprise an evaluation of the updated runtime environment using existing requests, e.g., existing optimization models.

In block 250, the updated runtime environment is implemented. In block 252, a historical job run persisted as a reference job run is re-run using the updated runtime environment. In case an error message, e.g., a solve error, is received, the method is continued in block 262 and the updated runtime environment marked as incompatible. In case no solve error is received, the method is continued in block 254. In block 254, a solve time required for re-running the historical job run using the updated runtime environment is compared with a historical solve time stored for the historical job run. The historical solve time is a solve time required for running the historical job run using a previous runtime environment. In case the solve time is longer than the historical solve time, the method is continued in block 262 and the updated runtime environment marked as incompatible. In case the solve time is not longer than the historical solve time, the method is continued in block 256. In block 256, a solve objective value resulting from re-running the historical job run using the updated runtime environment is compared with a historical solve objective value stored for the historical job run. The historical solve objective value is a solve objective value resulting from running the historical job run using the previous runtime environment. In case the solve objective value is worse than the historical solve objective value, the method is continued in block 262 and the updated runtime environment marked as incompatible. In case the solve objective value is not worse than the historical solve objective value, the method is continued in block 258. In block 258, it is checked, whether a further historical job run persisted as a further reference job run is available. In case a further historical job run is available, the method is continued in block 252 with re-running the further historical job run. In case no further historical job run is available, the method is continued in block 260. In block 260, the updated runtime environment is marked as being compatible with solution objectives of the re-run historical job runs. For example, the updated runtime environment is marked as being compatible with optimization models of the re-run historical job runs

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation, or garbage collection, but this does not render the storage device as transitory because the data is not transitory while it is stored.

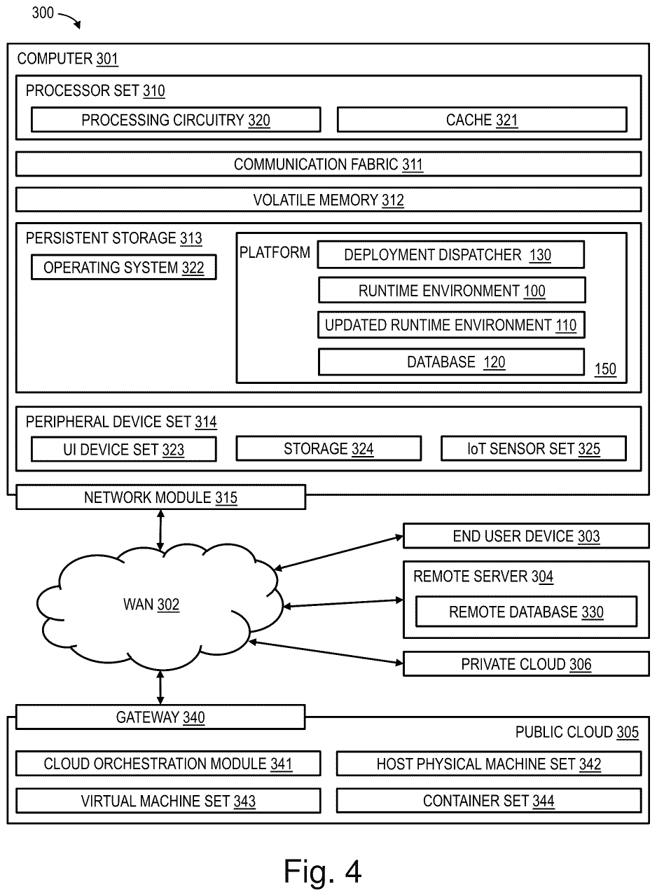

Referring now to FIG. 4, an illustrative computing environment 300 is depicted. Computing environment 300 contains an example of an environment for the execution of at least some of the computer code involved in performing the inventive methods, such as a platform 150. The platform 150 may, e.g., comprise a first runtime environment 100, an updated second runtime environment 110, a database 120 with persisted datasets of previous executions of previous requests, and a deployment dispatcher module 130 as described in FIG. 2. The platform 150 may, e.g., be configured to execute any of the methods of any of FIGS. 1 and 3. For an automated provision of the updated runtime environment 110, the platform 150 may, e.g., be configured to persist using the database 120 one or more datasets of one or more previous executions of one or more previous requests using the previous runtime environment 100. Such a dataset may comprise previous request data, which define the previous request and comprise a solution objective of the respective previous request. The dataset may further comprise previous request execution data, which are descriptive of the previous execution of the previous request. The updated runtime environment 110 may be implemented on the platform 150.

The updated runtime environment 110 may be evaluated using the dataset provided by the database 120. The evaluating may comprise submitting the previous request data to the updated runtime environment 110 for execution, receiving updated request execution data descriptive of the execution of the previous request by the updated runtime environment 110, and evaluating the received updated request execution data using the previous request execution data. In response to a positive evaluation, the updated runtime environment 110 may be marked as compatible with the solution objective defined by the previous request data. The deployment dispatcher module 130 may automatically switch to the updated runtime environment 110 for executions of further requests defined by further request data comprising a further solution objective matching the solution objective with which the updated runtime environment 110 is marked to be compatible. For example, the updated runtime environment 110 is a latest runtime environment of a plurality of runtime environments, which are marked to be compatible with the solution objective of the updated runtime environment. For example, the deployment dispatcher module 130 is configured for switching automatically to the updated runtime environment 110 upon a marking as compatible without a specific user interaction requesting and/or initiating the switching.

The platform 150 may, e.g., be provided by a cloud, e.g., a public cloud 305. The platform 150 may, e.g., communicate with user applications, e.g., executed on end user devices 303, via a network, e.g., via WAN 302.

In addition to component 150, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 200, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 4. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer-readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 200 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer-readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

Cloud computing services and/or microservices (not separately shown in FIG. 4): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, if necessary, and virtual private networks.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows: On-demand self-service: a cloud consumer can unilaterally provision computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service. Service Models are as follows: Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows: Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises. Public cloud: the cloud infrastructure is made available to the general public or a large industry group and is owned by an organization selling cloud services. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds). A cloud computing environment is service oriented with a focus on statelessness, low coupling, modularity, and semantic interoperability. At the heart of cloud computing is an infrastructure that includes a network of interconnected nodes.

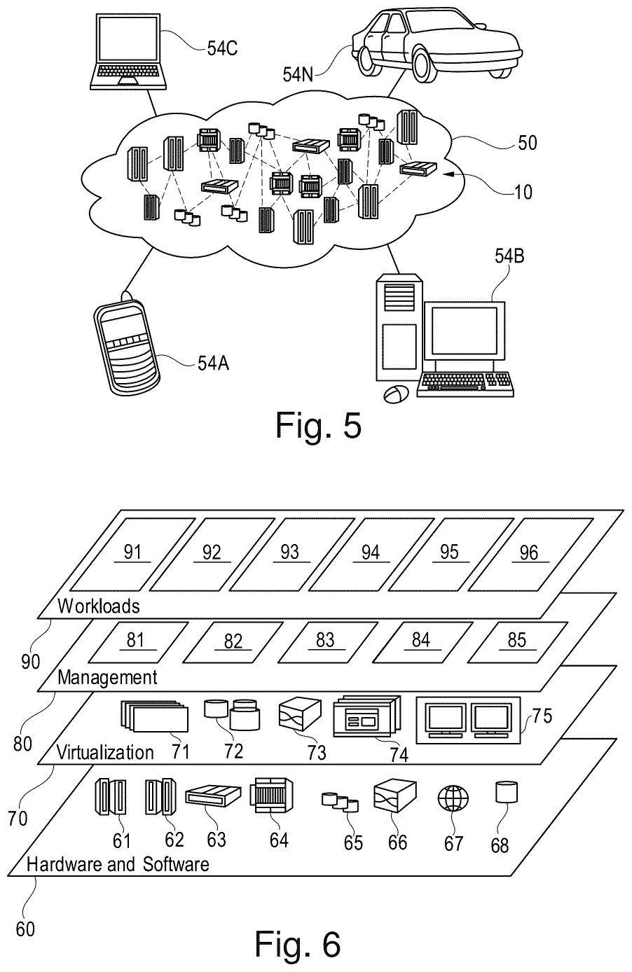

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and request executing 96 in accordance with any of the examples disclosed herein, which, e.g., are configured for automatically provisioning an updated runtime environment as described with reference to any of FIGS. 2, 4, and 5 and, e.g., configured to implement the methods described with reference to any of FIGS. 1 and 3 for automatically provisioning the updated runtime environment.

1. A computer-implemented method for an automated provision of an updated runtime environment, the method comprising:
persisting a dataset of a previous execution of a previous request using a previous runtime environment, the dataset comprising previous request data defining the previous request and comprising a solution objective of the previous request;
previous request execution data being descriptive of the previous execution of the previous request;
implementing the updated runtime environment; and
evaluating the updated runtime environment using the dataset, the evaluating comprising:
submitting the previous request data to the updated runtime environment for execution, receiving updated request execution data descriptive of the execution of the previous request by the updated runtime environment, and evaluating the received updated request execution data using the previous request execution data; and
in response to a positive evaluation, marking the updated runtime environment as compatible with the solution objective defined by the previous request data.

2. The method of claim 1, wherein the previous request execution data comprising a previous execution time required for the previous execution of the previous request by the previous runtime environment, the updated request execution data comprising an updated execution time required for the updated execution of the previous request by the updated runtime environment, the evaluating of the received updated request execution data comprising a checking that for the previous request data the updated execution time is not longer than the previous execution time.

3. The method of claim 1, wherein the previous request execution data comprising previous solution data for the solution objective, the solution data resulting from the execution of the previous request by the previous runtime environment, the updated request execution data comprising updated solution data for the solution objective, the updated solution data resulting from the updated execution of the previous request by the updated runtime environment, the evaluating of the received updated request execution data comprising a checking that for the previous request data a quality of the updated solution data according to a quality metric of the updated solution data is not less than a quality of the previous solution data according to a quality metric of the previous solution data.

4. The method of claim 3, wherein the quality metric of the previous solution data comprising a previous objective value of the previous solution data, the quality metric of the updated solution data comprising an updated objective value of the updated solution data.

5. The method of claim 1, wherein the evaluating of the received updated request execution data further comprising checking that the updated request execution data does not comprise an error message.

6. The method of claim 1 further comprising:
generating an evaluation report summarizing the evaluation.

7. The method of claim 6, wherein the evaluation report comprising one or more of the following: a summary of the comparison of the updated execution time with the previous execution time; a summary of the comparison of the updated solution data with the previous solution data; and a summary of received error messages.

8. The method of claim 6, wherein the method further comprising sending a notification with the evaluation report to one or more user applications notifying about the compatibility of the updated runtime environment with the solution objective defined by the previous request data and about the evaluation.

9. The method according to claim 1, further comprising:
automatically instructing a deployment dispatcher module to switch to the updated runtime environment for executions of further requests defined by further request data comprising a further solution objective matching the solution objective with which the updated runtime environment is marked to be compatible.

10. The method according to claim 9, further comprising:
sending a switching notification about the automatic switching to user applications, from which the further requests are received.

11. The method of claim 1, wherein the previous runtime environment using a previous version of a programming language for executing the previous request and the updated runtime environment using an updated version of the programming language for executing the previous request.

12. The method of claim 1, wherein the previous runtime environment and the updated runtime environment being configured for solving optimization problems, and the previous runtime environment comprising a previous optimization engine configured for determining results of optimization problems and the updated runtime environment comprising an updated optimization engine configured for determining results of optimization problems.

13. The method of claim 1, wherein the previous request data comprising input data with values defining a setup for a problem for which the solution objective is to be determined.

14. The method of claim 13, wherein the solution objective is comprised by a model, the model further defining one or more constraints of the problem for which the solution objective is to be determined.

15. The method of claim 13, wherein the problem is an optimization problem.

16. The method of claim 1, wherein a plurality of datasets of previous executions of a plurality of requests is persisted and at least a part of the plurality of the persisted datasets is used for the evaluating of the updated runtime environment, the updated runtime environment being marked compatible with all solution objectives defined by the datasets, for which the evaluation is positive.

17. The method of claim 16, wherein the part of the plurality of persisted datasets used for the evaluating of the updated runtime environment being datasets selected from the plurality of persisted datasets using a selection criterion.

18. The method of claim 17, wherein the selection criterion being one of the following: a predefined number of latest datasets of the plurality of persisted datasets, or a predefined number of latest datasets of the plurality of persisted datasets with different solution objectives.

19. A computing device for an automated provision of an updated runtime environment, the computing device comprising a processing unit and a memory unit with computer-readable program code embodied therewith, execution of the computer-readable program code by the processing unit causing the computing device to:
persist a dataset of a previous execution of a previous request using a previous runtime environment, the dataset comprising previous request data defining the previous request and comprising a solution objective of the previous request; previous request execution data being descriptive of the previous execution of the previous request; implement the updated runtime environment;
evaluate the updated runtime environment using the dataset, the evaluating comprising: submitting the previous request data to the updated runtime environment for execution, receiving updated request execution data descriptive of the execution of the previous request by the updated runtime environment, and evaluating the received updated request execution data using the previous request execution data; and
in response to a positive evaluation, mark the updated runtime environment as compatible with the solution objective defined by the previous request data.

20. A computer program product for automated provision of an updated runtime environment, the computer program product comprising a non-transitory computer-readable storage medium having computer-readable program code embodied therewith, an execution of the computer-readable program code by a processing unit of a computing device causing the computing device to:
persist a dataset of a previous execution of a previous request using a previous runtime environment, the dataset comprising previous request data defining the previous request and comprising a solution objective of the previous request; previous request execution data being descriptive of the previous execution of the previous request; implement the updated runtime environment;
evaluate the updated runtime environment using the dataset, the evaluating comprising: submitting the previous request data to the updated runtime environment for execution, receiving updated request execution data descriptive of the execution of the previous request by the updated runtime environment, evaluating the received updated request execution data using the previous request execute in data; and
in response to a positive evaluation, mark the updated runtime environment as compatible with the solution objective defined by the previous request data.
